(19) United States
(12) Patent Application Publication
(10) Pub. No.: US 2009/0207147 A1
(43) Pub. Date: Aug. 20, 2009

(54) TOUCH-SENSITIVE INTERFACE DEVICE AND METHOD

(76) Inventors: Alexandre Perrot, Vinay (FR); Sebastien Rigollet, Saint Laurent En Royans (FR)

Correspondence Address: YOUNG & THOMPSON, 209 Madison Street, Suite 500, ALEXANDRIA, VA, 22314, US

(21) Appl. No.: 12/372,885

(22) Filed: Mar. 27, 2009

(30) Foreign Application Priority Data
Feb. 18, 2008 (FR) 0851029

(51) Int. Cl. G06F 3/041

(52) U.S. Cl. 345/173

(57) ABSTRACT

A touch-sensitive interface device includes:—a touch-sensitive keypad including elements for generating a voltage as the effect of a mechanical deformation, and—a signal processing electronic interface adapted to detect pressing and/or releasing of a voltage generator elements and to go to standby after the pressing and/or the releasing of each voltage generator elements. The voltage generator elements preferably includes a piezoelectric element. In embodiments, the electronic interface includes at least one voltage comparator device, the generation of a parameterable threshold voltage to which the voltage comparator device compares the voltage at the terminals of a voltage generator element, and a card including a central processor unit and its power supply unit. The parameterable threshold voltage can be increased or decreased to detect positive and negative peaks of at least one voltage generator elements respectively caused by pressing or releasing at least one voltage generator elements.

### FIELD OF THE INVENTION

The present invention concerns a touch-sensitive interface device and method. It applies in particular to guaranteeing the autonomy of electronic products provided with a touch-sensitive man-machine interface (MMI) that are not connected to a permanent power supply.

### TECHNOLOGICAL BACKGROUND

Electronic solutions dedicated to touch-sensitive interfaces consume too much current to guarantee an autonomy of at least two years to products that are not connected to a permanent power supply.

Nomadic electronic products provided with a touch-sensitive interface that are not connected to a permanent power supply, such as portable digital music players, mobile telephones, personal digital assistants and geo-location systems, generally use rechargeable batteries. So-called “capacitive” touch-sensitive interface technologies offer very low consumption but cannot always enable a product to function normally for at least two years without intervention such as replacing the cell, recharging or replacing a battery or connecting the product to a power supply.

In devices using piezoelectric sensors, only pressure on the piezoelectric element is generally used. Devices that rely on pressing and releasing the piezoelectric sensor use central processor units (CPU) that continuously monitor the signal coming from the piezoelectric sensor. This implies that the central processor unit is always active and consequently reduced autonomy.

Also, many applications based on touch-sensitive MMI use the “capacitive” technology, necessitating a higher average current because the central processor unit is never on standby. This is not compatible with consumption constraints inherent to products employing non-rechargeable cells.

### OBJECT OF THE INVENTION

The present invention aims to remedy these drawbacks.

To this end, a first aspect of the present invention is directed to a touch-sensitive interface device, characterized in that it includes:

a touch-sensitive keypad including at least one means for generating a voltage as the effect of a mechanical deformation, and

a signal processing electronic interface adapted to detect pressing and/or releasing of a voltage generator means and to go to standby after the pressing and/or the releasing of each voltage generator means.

A second aspect of the present invention is directed to a touch-sensitive interface device, characterized in that it includes:

a touch-sensitive keypad including at least one means for generating a voltage as the effect of a mechanical deformation, and

a signal processing electronic interface adapted to detect releasing of a voltage generator means and to go to standby after each releasing of each voltage generator means.

The present invention therefore has the advantage that consumption when idle is equal only to the consumption of the electronic interface on standby, including the consumption of a central processor unit on standby. The efficacy of the present invention resides notably in the fact that its average consumption is extremely low. This is because the electronic interface is active substantially only for the duration of pressing a voltage generation means in order to execute the actions to be carried out. The rest of the time the electronic interface is “dormant”, the current consumed being a standby current.

The inventor has carried out tests which show that, in the current state of the art, it is possible, for example, to employ a touch-sensitive interface with at least five keys having an autonomy of at least two years for a product employing a single off-the-shelf “CR2032” (registered trade mark) cell.

According to particular features, the electronic interface includes at least one resistor bridge adapted to compare the voltage of at least one voltage generator means to a voltage corresponding to a release detection limit value.

According to particular characteristics, the voltage generator means include a piezoelectric element.

It will be recalled that mechanical deformation of a piezoelectric crystal generates an electrical voltage. The use of such elements enables manufacture at low cost.

According to particular features, the device of the present invention, as succinctly described above, includes a voltage generator means for each touch-sensitive key of said keypad.

Pressing each key is therefore processed in real time as soon as the key has been pressed. An action linked to pressing the key lasts for exactly as long as the key is pressed.

According to particular features, the electronic interface is adapted to detect positive and negative fluctuations in the voltage at the terminals of each means for generating a voltage respectively corresponding to pressing and releasing the voltage generator means.

The precise times of pressing and releasing the key are therefore detected.

According to particular features, the electronic interface is adapted to compare the voltage at the terminals of each voltage generator means with at least one “upper” threshold voltage to detect the pressing of a key associated with a voltage generator means and with at least one “lower” threshold voltage, to detect the releasing of said key.

Thus the binary signal corresponding to the result of these two comparisons assumes a predetermined value for as long as the voltage generator means is pressed.

According to particular features, the electronic interface includes at least one voltage comparator means and one means for modifying the threshold voltage to which said voltage comparator means compares the voltage at the terminals of a voltage generator means.

Thanks to these features, one voltage comparator means is sufficient to detect positive and negative fluctuations in the voltage at the terminals of a voltage generator means.

According to particular features, the threshold voltage modification means is adapted to reduce the threshold voltage when it has been exceeded by the voltage at the terminals at a voltage generator means.

According to particular features, said electronic interface includes at least one voltage comparator means adapted to compare a voltage at the terminals of each voltage generator means with a threshold voltage, the electronic interface being on standby when said voltage is less than said threshold voltage.

It is therefore particularly simple to implement the present invention.

According to particular features, the electronic interface includes a central processor unit adapted to effect a different action upon the pressing and/or the releasing of each voltage generator means.

Thus the device of the present invention can control multiple actions or functions according to the key or keys that a user presses.

A second aspect of the present invention is directed to a switch characterized in that it includes an interface device of the present invention as succinctly described above.

A third aspect of the present invention is directed to a dimmer characterized in that it includes an interface device of the present invention as succinctly described above.

A fourth aspect of the present invention is directed to a remote controller characterized in that it includes an interface device of the present invention as succinctly described above.

A fifth aspect of the present invention is directed to a touch-sensitive interfacing method characterized in that it includes:

a step of detecting pressing and/or releasing a voltage generator means of a keypad and activating an electronic interface, and

a step of returning said electronic interface to standby.

The advantages, objects and features of this switch, this dimmer and this method being similar to those of the device of the present invention, as succinctly described above, they are not repeated here.

### BRIEF DESCRIPTION OF THE DRAWINGS

Other advantages, objects and features of the present invention will emerge from the following description given, by way of explanation and in no way limiting on the invention, with reference to the appended drawings, in which:

FIG. 1 represents diagrammatically one particular embodiment of the device of the present invention,

FIG. 2 represents diagrammatically the evolution of a voltage at the terminals of a piezoelectric element on pressing and releasing a keypad key associated with that piezoelectric element,

FIG. 3 represents one particular embodiment of the switch of the present invention,

FIG. 4 represents one particular embodiment of the dimmer of the present invention,

FIG. 5 represents one particular embodiment of the device of the present invention incorporated into a remote controller keypad,

FIG. 6 represents an electrical circuit diagram of one particular embodiment of the device, and

FIG. 7 represents a flowchart of the steps of one particular embodiment of the method of the present invention.

### DETAILED DESCRIPTION OF ONE EMBODIMENT

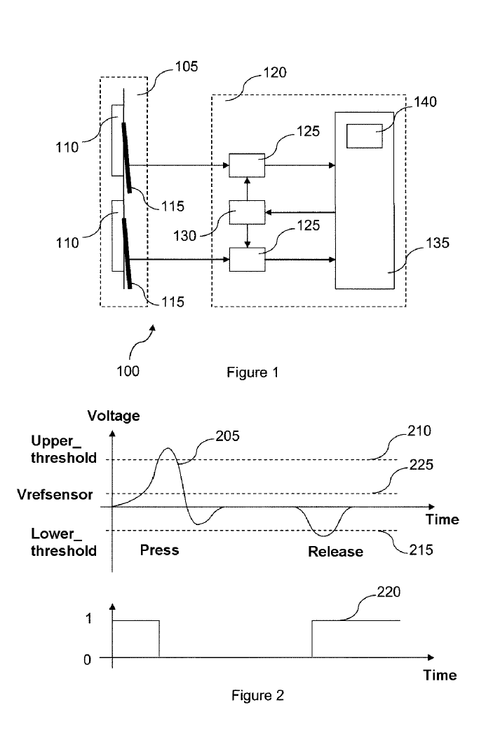

It is seen, in FIG. 1, that, in one particular embodiment, the device 100 includes, on the one hand, a keypad 105 including keys 110 and voltage generator means 115 and, on the other hand, an electronic interface 120 including voltage comparator means 125, a means 130 for modifying threshold voltages applied to the voltage comparator means 125, and a central processor unit card 135.

The central processor unit card 135 includes a power supply unit 140. The central processor unit is, for example, based on a microcontroller, a digital signal processor (DSP) or a component including a processor.

The voltage generator means 115 are adapted to generate a voltage when they are mechanically deformed. The voltage generator means 115 preferably include piezoelectric elements mechanically associated with the keys of the keypad in a manner that is known in itself. For example, the keypad 105 consists of a block consisting of a sandwich of a number of materials, including the materials of the piezoelectric elements. On the front face of this keypad 105 are pictograms identifying the areas that the user must press. Under each pictogram there is a piezoelectric element. This touch-sensitive block is supplied with a flexible layer including two ground signals and the piezoelectric signals. A connector makes the electrical connection to those signals. It is seen that each key of the keypad 105 is associated with a voltage generator means 115, a voltage comparator means 125, and an input of the central processor unit 135.

The threshold voltage modification means 130 supplies the same threshold voltage to all the voltage comparator means 125. However, as an alternative to this, one threshold voltage modification means is provided for each key of the keypad 105. This variant applies in particular to the situation in which pressing a number of different keys in parallel is to be detected.

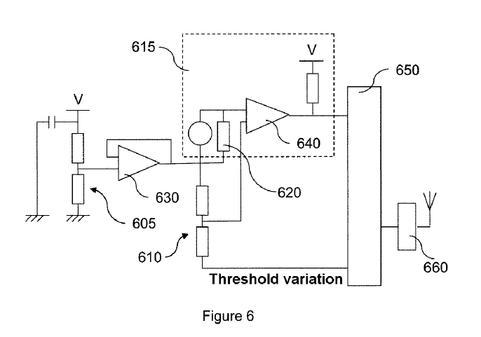

Each voltage generator means 115 is loaded by a resistor 620 (see FIG. 6), the resulting voltage being fed to the “−” input of a voltage comparator means 125, while the threshold voltage supplied by the threshold voltage modification means 130 is applied to the “+” inputs of the voltage comparator means 125.

The outputs of all the voltage comparator means 125 are connected to interrupt inputs of a central processor unit 650 of the card 135, which is, for example, a component including a processor (see FIG. 6). Thus when an output signal of a voltage comparator means 125 switches to “0”, the central processor unit, which was in standby mode, is activated. Conversely, when the output signals of all the voltage comparator means 125 return to “1”, the central processor unit returns to standby mode.

The threshold voltage modification means 130 is such that the threshold voltage assumes, continuously, one of two threshold voltages, namely an “upper_threshold” voltage and a “lower_threshold” voltage. These threshold voltages are chosen so that upper_threshold=Vrefsensor+E1 and lower_threshold=Vrefsensor−E2, with E1>0, E2>0 and Vrefsensor being the reference voltage of the piezoelectric element 115, i.e. its voltage at rest.

The comparator means 125 compare the voltage at the terminals of the piezoelectric elements 115 to the threshold voltage, the signal resulting from this comparison being a binary signal comprehensible by any central processor unit. In the embodiment described, this binary signal has the value “1” when the key is at rest and “0” for as long as the key is pressed.

For each voltage comparator means 125 associated with a key 110 of the touch-sensitive keypad 105, the voltage from the corresponding piezoelectric element 115 is applied to the “−” input of the voltage comparator means 125 while the threshold voltage supplied by the modification means 130 is applied to the “+” input of that voltage comparator means 125. Thus, at rest, the output of the voltage comparator means 125, connected to an interrupt input of the central processor unit, has the value “1”. The central processor unit is on standby and can be activated as soon as this input switches to “0”.

The modification means 130 consists of a central processor unit, generally the same as described above, and a resistor bridge (see FIG. 6) that receives a signal from the “threshold variation” output of the central processor unit. On pressing it, the output voltage of the piezoelectric element 115 becomes greater than “upper_threshold” and the output of the voltage comparator means switches to “0”. The central processor unit is activated and immediately switches a “threshold variation” output line to “0” (this line is at “1” at rest). This line modifies the threshold voltage applied by the modification means 130 to the “+” inputs of the voltage comparator means 125, with the result that the output voltage of the piezoelectric element 115 is above the threshold (“lower_threshold”). The output of the voltage comparator means 125 therefore remains at “0” until releasing of the key is detected. The outputs of all the other voltage comparator means 125 also go to “0” when the threshold voltage changes, the output voltages of the voltage generator means all being above “lower_threshold”. As soon as release occurs, the output voltage of the voltage generator means 115 becomes momentarily less than “lower_threshold”, the output of the voltage comparator means 125 corresponding to the key 105 that was pressed therefore returns to “1”, and the central processor unit then immediately switches the “threshold variation” line to “1”, to await another press because the outputs of all the voltage comparator means 125 are switched back to “1” when the threshold voltage is switched to “upper_threshold”.

Accordingly, in embodiments, the signal processing electronic interface detects the release of a voltage generator means and goes to standby after each release of each voltage generator means.

In embodiments, the signal processing electronic interface detects the pressing and/or the releasing of a voltage generator means and goes to standby after each pressing and/or releasing of each voltage generator means.

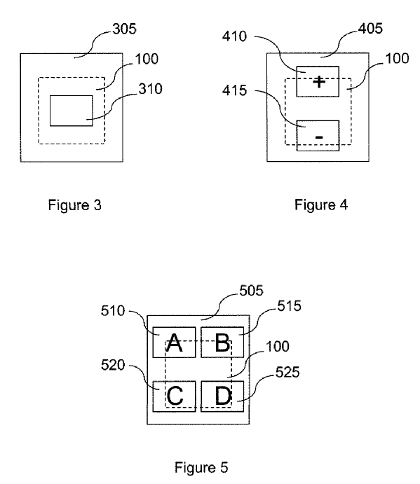

Using voltage comparator means 125 with very low consumption, such as the Maxim MAX9120 (registered trade mark) comparator, the standby current of which is 0.45 μA with a supply voltage of 3 V, enables the production, for example, of switches (see FIG. 3) or lighting dimmers (see FIG. 4) provided with a touch-sensitive interface using an off-the-shelf “CR2032” cell having an autonomy of two years with no change of cell.

Thus the device of the present invention uses a touch-sensitive keypad including voltage generator means, preferably piezoelectric elements, in which mechanical deformation generates an electrical voltage, and a signal processing electronic interface of very low consumption. This low consumption is achieved, on the one hand, by taking the electronic interface out of the standby state only when a piezoelectric element has been activated and returning it to the standby state as soon as that element is released, and, on the other hand, by using low-voltage voltage comparator means.

The average consumption of this interface depends directly on the number of touch-sensitive keys to be used, because of the number of voltage comparator means, which corresponds to the number of keys.

For example, the inventor has produced an interface having at least five keys having an autonomy of at least two years for a product using a single off-the-shelf “CR2032” cell.

One advantage of using the present invention is that the consumption at rest is equal only to the consumption of the electronic interface, including the consumption of the central processor unit on standby. The central processor unit is activated when the binary signal (corresponding to the piezoelectric key pressed) goes from “1” to “0”. The consumption of the piezoelectric keypad being zero.

In a variant that is not shown, the electronic interface includes at least one voltage comparator means adapted to compare a voltage at the terminals of each voltage generator means with a threshold voltage, the electronic interface being on standby when the voltage at the terminals of each voltage generator means is less than the threshold voltage. Using the present invention is then particularly simple.

There is seen, in FIG. 2, the evolution of a signal 205 corresponding to the voltage at the terminals of a piezoelectric element that is pressed and then released. An “upper_threshold” value 210 and a “lower_threshold” value 215 are also seen. Further seen are the reference voltage “Vrefsensor” 225 and a binary signal 220 representing the results of comparing the voltage represented by the signal 205 with the threshold value 210 and then, once that value has been exceeded, with the threshold value 215. The voltage at the terminals of a piezoelectric element is equal to “Vrefsensor” in the absence of mechanical deformation at the corresponding key or in the presence of permanent mechanical deformation.

The electronic interface detects the positive peak corresponding to pressing a key of the keypad if the voltage at the terminals of the voltage generator means is above “upper_threshold”, and then the negative peak corresponding to releasing the key, when that voltage falls below “lower_threshold”. Thus the binary signal at the output of the voltage comparator means has the value “0” for as long as the key associated with the piezoelectric element is pressed, as shown in FIG. 2.

The central processor unit card changes the threshold voltage as soon as it leaves the standby state, i.e. as soon as a voltage comparator means 125 detects that the voltage at the terminals of a piezoelectric element exceeds the “upper_threshold” value. The “lower_threshold” value then becomes the reference voltage for all the voltage comparator means 125.

At rest, when none of the keys of the keypad is pressed, the voltages at the terminals of the piezoelectric elements are equal to Vrefsensor and the outputs of all the voltage comparator means are at the “1” level.

When a key of the keypad is pressed, the voltage at the terminals of the corresponding piezoelectric element forms a positive peak that exceeds the “upper_threshold” value. This is because, when a piezoelectric sensor is pressed, electric charges are generated that flow in the resistor 620: this generates a peak in the voltage.

The output of the corresponding voltage comparator means then switches to the “0” level, when the voltage at the terminals of the piezoelectric element crosses the “upper_threshold” value. The central processor unit is then activated immediately and assigns the threshold voltage control signal the “lower_threshold” value. After it has exceeded the “upper_threshold” value, the voltage at the terminals of the piezoelectric element returns to “Vrefsensor” while the key is held pressed, the “Vrefsensor” value being greater than the new threshold voltage “lower_threshold”. The output of the voltage comparator means therefore remains at the “0” level and the central processor unit therefore remains activated and executes an action that has been programmed for pressing the key concerned.

At the moment when the key ceases to be pressed, the voltage at the terminals of the corresponding piezoelectric element forms a negative peak that crosses in the downward direction the “lower_threshold” value. This is because, when the piezoelectric sensor is released, there is a transfer of electrical charges in the opposite direction to that corresponding to the starting of pressing and therefore generation of a negative voltage peak.

The output signal of the corresponding voltage comparator means therefore goes to “1”, which causes the “threshold variation” control signal to be switched immediately to “1” and assigns the “upper_threshold” value to the threshold voltage. Thus all the other voltage comparator means again supply the same output signal at “1”, each voltage at the terminals of one of the piezoelectric elements being equal to “Vrefsensor”, i.e. between “lower_threshold” and “upper_threshold”.

The central processor unit then goes to the standby state, thus minimizing electrical consumption.

There is seen in FIG. 3 a switch 305 including the device 100 shown in FIG. 1. Pressing a key 310 switches the switch from one state to another. There is seen in FIG. 4 a dimmer 405 including the device 100 shown in FIG. 1. Pressing a “+” key 410 commands an increase in a control signal, for example a brightness control signal. Pressing a “−” key 415 commands reduction of the control signal. There is seen in FIG. 5 a remote controller 505 including the device 100 shown in FIG. 1. Pressing the keys 510 to 525 controls a remote device, for example an alarm, an electric lock or motors of a home automation installation.

The device 100 is represented in dashed line in FIGS. 3 to 5 because it is behind the front face of the switch, the dimmer or the remote controller, respectively.

Thus thanks to the electronic interface 120 it is possible to associate the execution of precise actions (such as switching on or adjusting a light source) while pressing a key 110 of the keypad 105. These actions can also be associated only with the signals at the start of pressing and/or releasing the keys 110.

With regard to the dimmer 405 shown in FIG. 4, it is thus possible to increase the brightness of a light source progressively, by maintaining the finger pressed on the “+” key, and to reduce the brightness progressively by holding the finger pressed on the “−” key.

In FIG. 6 there are shown only the components relating to one key of the keypad. To constitute a device using a number of keys, the components within a dashed line are duplicated. The inputs of the central processor unit that concern the various keys are different, however.

It is seen in FIG. 6 that the reference voltage of the piezoelectric elements 615 is provided by a first resistor bridge 605 followed by an operational amplifier 630 configured as a follower circuit. A second resistor bridge 610 with its terminals connected to the output of the operational amplifier 630 and to receive the “threshold variation” command coming from a central processor unit 650 supplies the “upper_threshold” or the “lower_threshold” voltage to a voltage comparator means 640 that also receive the voltage at the terminals of the piezoelectric element 615. The output signal of the voltage comparator means 640 is connected to an interrupt input of the central processor unit 650. The central processor unit 650 is connected to a radio-frequency communication circuit 660 to transmit radio signals.

In one particular implementation, the supply voltage V is equal to 3.3 V. The two resistors of the first resistor bridge 605 being equal, the reference voltage is 1.65 V. The resistance of the second resistor bridge 610 connected to the reference voltage being equal to 7.5% of the resistance connected to the “threshold variation” output of the central processor unit 650, when the “threshold variation” signal has the logic value “1”, i.e. has the value 3.3 V, the “upper_threshold” voltage has the value 1.77 V, and when the “threshold variation” signal has the logic value “0”, i.e., has the value 0 V, the “lower_threshold” voltage has the value 1.53 V.

If high resistances are chosen, the two divider bridges consume 0.24 μA in total. Using a voltage comparator means consisting of a Maxim MAX9120 (registered trade mark) comparator, which consumes approximately 0.45 μA at 3 V on standby, and a Maxim MAX4464 (registered trade mark) operational amplifier consumes 0.75 μA at 3 V. For a device with N keys and therefore N voltage comparator means, the current consumed on standby is therefore equal to (0.24+N×0.45+0.75) μA, to which must be added the current consumption of a central processor unit on standby, which is less than 1 μA for a microcontroller.

With regard to FIG. 6, the means for modifying the threshold voltage to which the voltage comparator means 640 compares the voltage at the terminals of a voltage generator means 615 consists of the resistor bridge 610, one point of which is connected to a binary output (“threshold variation”) of the central processor unit 650, which gives two possible threshold voltage values.

Note that, as an alternative to this, the comparator means are incorporated in the central processor unit 650. This eliminates a number of components, which reduces the cost and the consumption of the device.

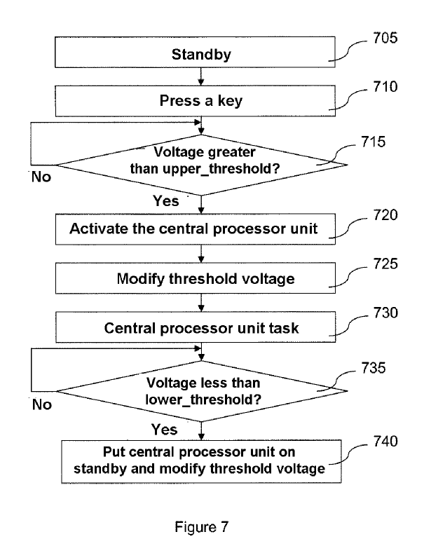

It is seen in FIG. 7 that a device of the present invention is in an initial standby state during a step 705.

During a step 710, a user presses a key of the keypad of the device.

During a step 715, it is determined if the voltage at the terminals of each voltage generator means is greater than the “upper_threshold” value. If not, the process returns to the step 715. If so, a central processor unit is activated during a step 720.

During a step 725, the central processor unit modifies the threshold voltage that is compared to the voltage at the terminals of the voltage generator means for which the crossing of the initial threshold value (“upper_threshold”) has been detected during the step 715. The new threshold value has the value “lower_threshold”.

During the step 730, the central processor unit carries out a task linked to the key that has been pressed since the step 710. For example, the central processor unit modifies the state of a switch or a dimmer to increase or decrease a signal, for example a control signal for lighting, a motor, an actuator, an electronic or information technology system.

Then, during a step 735, it is determined if the voltage at the terminals of each voltage generator means is less than the “lower_threshold” value. If not, the process returns to the step 730. If so, during a step 740, the central processor unit is put on standby.

Alternatively, placing the central processor unit on standby is deferred by the central processor unit, for example so that it can finish a task or store parameter values useful for the next time it is activated. Alternatively, when a user presses a key of the keypad, this triggers an action after a particular time period. When it is activated by an output signal from one of the voltage comparator means, the central processor unit can decide to act immediately or to wait.

Alternatively, when a user presses a key, that triggers an action commanded by the central processor unit followed by the central processor unit automatically going to standby. Alternatively, account is taken only of pressing a key or releasing a key to carry out an action. A single threshold voltage value can then be used. Alternatively, when a user releases the key, that triggers a new action and a return to standby. Two threshold voltages are then used and maintained during the standby phases.

The present invention applies to all devices liable to include a touch-sensitive interface.

1. A touch-sensitive interface device (100), which includes:
a touch-sensitive keypad including at least one means for generating a voltage as the effect of a mechanical deformation, and
a signal processing electronic interface adapted to detect pressing and/or releasing of a voltage generator means and to go to standby after the pressing and/or the releasing of each voltage generator means.

2. The device as claimed in claim 1, wherein the voltage generator means includes a piezoelectric element.

3. The device as claimed claim 1, which includes a respective voltage generator means for each touch-sensitive key of said keypad.

4. The device as claimed in claim 1, wherein the electronic interface is adapted to detect positive and negative fluctuations in the voltage at the terminals of each means for generating a voltage respectively corresponding to pressing and releasing the voltage generator means.

5. The device as claimed in claim 1, wherein the electronic interface is adapted to compare the voltage at the terminals of each voltage generator means with at least one “upper” threshold voltage to detect the pressing of a key associated with a voltage generator means and with at least one “lower” threshold voltage, to detect the releasing of said key.

6. The device as claimed in claim 5, wherein the electronic interface includes at least one voltage comparator means and one means for modifying the threshold voltage to which said voltage comparator means compares the voltage at the terminals of a voltage generator means.

7. The device as claimed in claim 6, wherein the threshold voltage modification means is adapted to reduce the threshold voltage when it has been exceeded by the voltage at the terminals of a voltage generator means and to increase the threshold voltage when it has been crossed in the downward direction by the voltage at the terminals of said voltage generator means.

8. The device as claimed in claim 1, wherein said electronic interface includes at least one voltage comparator means adapted to compare a voltage at the terminals of each voltage generator means with a threshold voltage, the electronic interface being on standby when the voltage at the terminals of each voltage generator means is less than said threshold voltage.

9. The device as claimed in claim 1, wherein the electronic interface includes a central processor unit adapted to effect a different action upon the pressing and/or the releasing of each voltage generator means.

10. A switch, which includes an interface device as claimed in claim 1.

11. A dimmer, which includes an interface device as claimed in claim 1.

12. A remote controller, which includes an interface device as claimed in claim 1.

13. A touch-sensitive interface method, which includes:
a step of detecting pressing and/or releasing of a voltage generator means of a keypad and activating of an electronic interface, and
a step of returning said electronic interface to standby.

14. The device as claimed claim 2, which includes a respective voltage generator means for each touch-sensitive key of said keypad.

15. The device as claimed in claim 2, wherein the electronic interface is adapted to detect positive and negative fluctuations in the voltage at the terminals of each means for generating a voltage respectively corresponding to pressing and releasing the voltage generator means.

16. The device as claimed in claim 3, wherein the electronic interface is adapted to detect positive and negative fluctuations in the voltage at the terminals of each means for generating a voltage respectively corresponding to pressing and releasing the voltage generator means.

17. The device as claimed in claim 2, wherein said electronic interface includes at least one voltage comparator means adapted to compare a voltage at the terminals of each voltage generator means with a threshold voltage, the electronic interface being on standby when the voltage at the terminals of each voltage generator means is less than said threshold voltage.

18. The device as claimed in claim 2, wherein the electronic interface includes a central processor unit adapted to effect a different action upon the pressing and/or the releasing of each voltage generator means.
